(19) United States
(12) Patent Application Publication
(10) Pub. No.: US 2003/0009388 A1
(43) Pub. Date: Jan. 9, 2003

(54) Method and system for remote processing of orders for products and/or services from wireless devices

(76) Inventors: Steven J. Simonyi-Gindele, Vancouver (CA); John Elliott Barham, Vancouver (CA); Li Min Mark Qin, Burnaby (CA)

Correspondence Address: Bruce M. Green, c/o Oyen Wiggs Green & Mutala, #480 - 601 West Cordova Street, Vancouver, BC, V6B 1G1, CA

(21) Appl. No.: 09/897,920

(22) Filed: Jul. 5, 2001

(51) Int. Cl. G06F 17/60

(52) U.S. Cl. 705/26

(57) ABSTRACT

Prior methods of ordering goods over the Internet do not provide real time updating of inventory and customer information, nor do they permit access from multiple Internet-accessible devices such as personal digital assistants and WAP wireless telephones. The present invention provides a solution to that problem.

### TECHNICAL FIELD

The invention relates to the field of use of the Internet for maintaining a database of updated information, and more particularly to a method and system for processing sales orders over the Internet using wireless devices such as personal digital assistants or cellular telephones.

### BACKGROUND ART

The Internet has been widely used for retail sales of products to allow customers to remotely order, and obtain delivery of, products such as books or music over a web site such as amazon.com, or groceries over a web site such as webvan.com. Typically this has been done from a personal computer using a wired connection. However, increasingly access to the Internet is made through a variety of devices, including wireless devices such as personal digital assistants (PDA's) or cellular telephones. Use of bar code readers has also been utilized in conjunction with Internet-accessible devices to facilitate self-service shopping (see U.S. Pat. No. 6,199,753 issued Mar. 13, 2001; U.S. Pat. No. 6,101,483 issued Aug. 8, 2000 and U.S. Pat. No. 5,434,394 issued Jul. 18, 1995) and for tracking objects such as packages during shipping (see U.S. Pat. No. 5,869,819).

In many sales situations it is not useful to have customers making direct product selections and ordering, but rather it is preferable to have ordering done through sales agents acting on-site at the customer's premises. For example a manufacturer or distributor may have a line of products which is sold wholesale to a retail merchant and which is rapidly changing as to consumer demand, current features etc. In such a situation, the merchant may require on-site assistance from a sales agent as to the selection from the product line, quantities which should be ordered and the like. Such sales agents travel from customer to customer in a day. However it is important that their orders be received at their central location in a timely way so that it is ensured that there is an adequate inventory to meet such orders, and so that orders are processed as quickly as possible. In the past, devices have existed which allow sales agents to store orders over the course of a day and download the collected orders periodically over a modem and telephone line. See for example U.S. Pat. No. 4,525,624 issued Jun. 25, 1985. However such systems require specialized equipment and connection to a telephone line, which may be inconvenient for the sales agent, and do not permit the real time updating of the sales agent's information on inventory and product information.

There is therefore a need for a method and system for real-time processing of product orders conducted over the Internet using a wireless device such as a PDA or cellular telephone.

### DISCLOSURE OF INVENTION

The invention therefore provides a method of using a global computer network to communicate product sales orders from one of a plurality of customer agents, each agent having an Internet accessible device with data storage, to one of a plurality of client computer systems, each client computer system comprising a database of product information, inventory, and customer information, the client computer system being accessible to the Internet; the method comprising:

a) providing a system server accessible to the client computer system via the Internet and comprising a database, the system server thereby being adapted to interactively communicate data to and from the client computer system via the Internet;

b) constructing a client database associated with the system server by periodically updating product information, inventory, and customer information for specific clients and storing in said database the data organized according to customer agents and product categories and product description records for each product;

c) said system server being accessible to the agents' devices via the Internet, the system server thereby being adapted to interactively communicate data to and from the agents' devices via the Internet;

d) communicating to one of the agents, product information, inventory, and customer information;

e) the agent composing a customer product order and storing same on the device;

f) the agent communicating order information to the system server;

g) the system server updating the client database with the order information;

h) the system server communicating the updated client database information to the client computer system.

The invention further provides a system for communicating product sales orders from one of a plurality of customer agents, each agent having an Internet accessible device with data storage, to one of a plurality of client computer systems, each client computer system comprising a database of product information, inventory, and customer information, the client computer system being accessible to the Internet, the system comprising:

a) a system server accessible to the client computer system and to the agent's Internet accessible device via the Internet and comprising a database, the server thereby being adapted to interactively communicate data to and from the client computer system and to and from the agent's Internet accessible device via the Internet;

b) a client database associated with the server by periodically updating product information, inventory, and customer information for specific clients and storing in the database the data organized according to customer agents and product categories and product description records for each product;

c) means for communicating to one of the agents, product information, inventory, and customer information;

d) means for the agent to compose a customer product order and storing same on the device;

e) means for the agent to communicate the order to the system server; and

f) means for the system server to communicate the order to the client computer system.

More generally, the invention provides a method of using a global computer network to communicate information from one of a plurality of client agents, each agent having an Internet accessible device, to one of a plurality of client computer systems, each client computer system comprising a database of information, and to update the information in the client computer system database, the client computer system being accessible to the Internet; the method comprising:

a) providing a system server accessible to the client computer system via the Internet and comprising a database, the system server thereby being adapted to interactively communicate data to and from the client computer system via the Internet;

b) constructing a client database associated with the server by periodically updating information and storing the information in the database;

c) the system server being accessible to the agents' devices via the Internet, the server thereby being adapted to communicate information from the agents' devices via the Internet;

d) the agent composing a communication including updated information on the device;

e) the agent communicating the updated information to the system server via the Internet;

f) the system server updating the information in the client database; and

g) the system server periodically communicating the updated information to the client computer system.

### BRIEF DESCRIPTION OF DRAWINGS

In drawings which disclose a preferred embodiment of the invention,

FIG. 1 is a schematic block diagram illustrating a computer network for carrying out the invention;

FIG. 2 is a schematic diagram illustrating the software architecture designed to carry out the invention;

FIG. 3 is a flowchart illustrating the method of the invention;

FIG. 4 illustrates a screen display of a sales agent PDA showing an order being prepared; and

FIG. 5 illustrates a screen display of a sales agent PDA showing a completed order.

### BEST MODE(S) FOR CARRYING OUT THE INVENTION

The following terms have the following meanings in this disclosure:

Glossary of Terms:

Client: The business which uses the invention for remote sales order processing by its sales agents.

Client enterprise system: The accounting and inventory system used by the Client. Data from this system is used to create the Client import file, discussed below.

Customer: An individual or business to whom the Client sells its products or services using the invention.

System server: The Internet server containing the system database, system data model, and the software required to make the data available.

PDA: Personal Digital Assistant. The handheld computer device salespeople use to create order and consult product inventory levels.

Wireless Device: Any wireless telecommunications device such as a cellular telephone, mobile phone, smart phone, pager, vehicle onboard data terminal, personal digital assistant and the like.

Import file: The file that is received from the client enterprise system, then is parsed to access the information regarding products, inventory, customer, and address information. This parsed data is then uploaded to field sales agents' PDAs when they access the System server. The format of this file is published for Clients.

Export file: The file that the system generates to provide the client enterprise system with the information regarding orders field sales agents have transmitted from the PDA to the System server.

PDA software: The software application that is downloaded to the PDA to provide sales automation functionality.

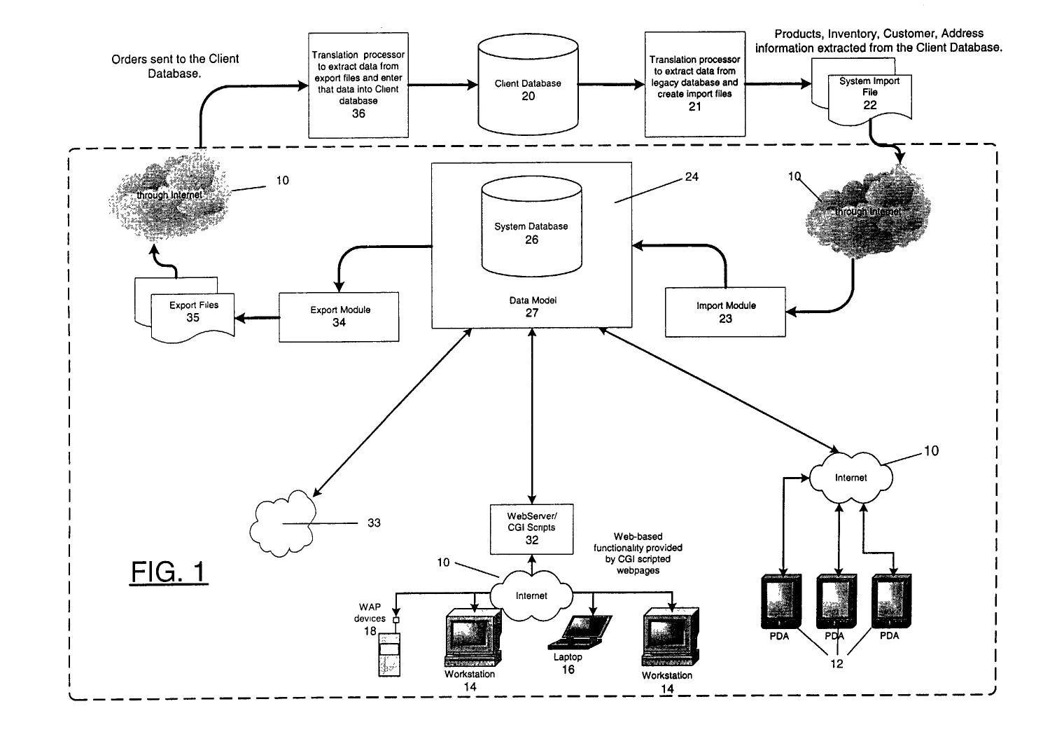

With reference to FIG. 1, the Client, on its client enterprise system, maintains a computer database 20 of its current product information, inventory, and customer information, including address information. The product, inventory, customer, and address information is extracted from the Client database 20 through the database's existing export utility. The exported information will be in a file format pre-determined for the system of the invention. The client files are then translated into the specified System import file format 22 by translation processor 21. The System import file 22 is subsequently sent to the System server 24 through a secure connection via a network such as the Internet 10. Once the System server 24 has received the System import file 22, the information will be extracted from the System import file and placed into the System database 26. This data will then be available when sales agents synchronize their PDAs 12 with the System server 24.

A number of sales agents have access to the Internet network 10 via wireless PDA's 12 devices. For such PDA's 12 to access the System server 24 via the Internet 10, each downloads, using HOTSYNC™ or other synchronization software, Internet accessing order entry application software. Using such order entry application software, the PDA 12 is able to access the Internet by wireless or telephone connection through an Internet Service Provider or other Internet access server to System server 24. Alternatively, sales agents access Internet 10 and System server 24 via standard Internet-accessible computer terminals 14, laptop 16 or Wireless Application Protocol (“WAP”), 3G or iMode device 18 through web server 32 by pointing a standard browser where the user is on a standard computer terminal (or WAP browser for a WAP device, such as Microsoft™ Mobile Explorer™ or Phone.com's UP.Browser microbrowser) at the System server 24's URL. In that case the agent is able to send data using CGI (Common Gateway Interface) scripted web pages. Future devices 33 may also allow the agent to access the System server 24 via the Internet or otherwise.

When the sales agent accesses the System server 24 with his or her PDA, the product, inventory, customer and address information is extracted from the System database 26 by the System server data model 27. The System server data model 27 identifies the particular sales agent and selects the information that the sales agent can access from the total data for the Client company which the sales agent represents, which will typically be the information for only certain of the Client's customers which the sales agent represents, organizes the information into the appropriate format for the PDA software and passes the information to the PDA 12. The PDA 12 will make use of this information and may modify this information, but only the customer and address information will be uploaded from the PDA 12 to the System server 24 at this stage.

Using information sent from the System server 24 to the PDA 12, the sales agent can create orders on the PDA 12 using the PDA software. These orders are stored on the PDA, and then passed to the System server 24 the next time the PDA 12 accesses the System server 24. At this time, any orders on the PDA that are categorized as “complete” status automatically are converted to “final” status and can no longer be modified on the System server 24 or on the PDA 12. Once the orders are in the System database 26 and the client requests the data, the orders are provided to the client in a System export file 34 via Internet 10. The System export file 34 is then translated back into the client file format 22 by translation processor 36. The System export file may then be imported into the client's enterprise system and orders can be processed for billing, packing and shipping.

The sales agent may create orders directly into the System server database 26 via their web browser 14. As changes are made to the order, the changes are reflected in the System server database 26. These orders are equivalent to the orders that originate on the PDA 12, and therefore are exported to the client's accounting system to be processed for billing, picking and shipping as System export files as described above.

As indicated above, the System server 24 server can also be accessed by the sales agent using other types of devices besides a PDA. This is done via a standard desktop PC web browser 14. When a sales agent accesses the System server web interface and requests a page containing product, inventory, customer and/or address information, the data is extracted from the System server database 26. The requested data is extracted and manipulated by the System server data model. The resulting files are then sent to the sales agent's web browser 14 to be viewed or modified. The System server data model is designed to allow for accessing by other hardware 33 not yet developed by using a device-independent Internet protocol. This enables future developments to incorporate other hardware devices 33.

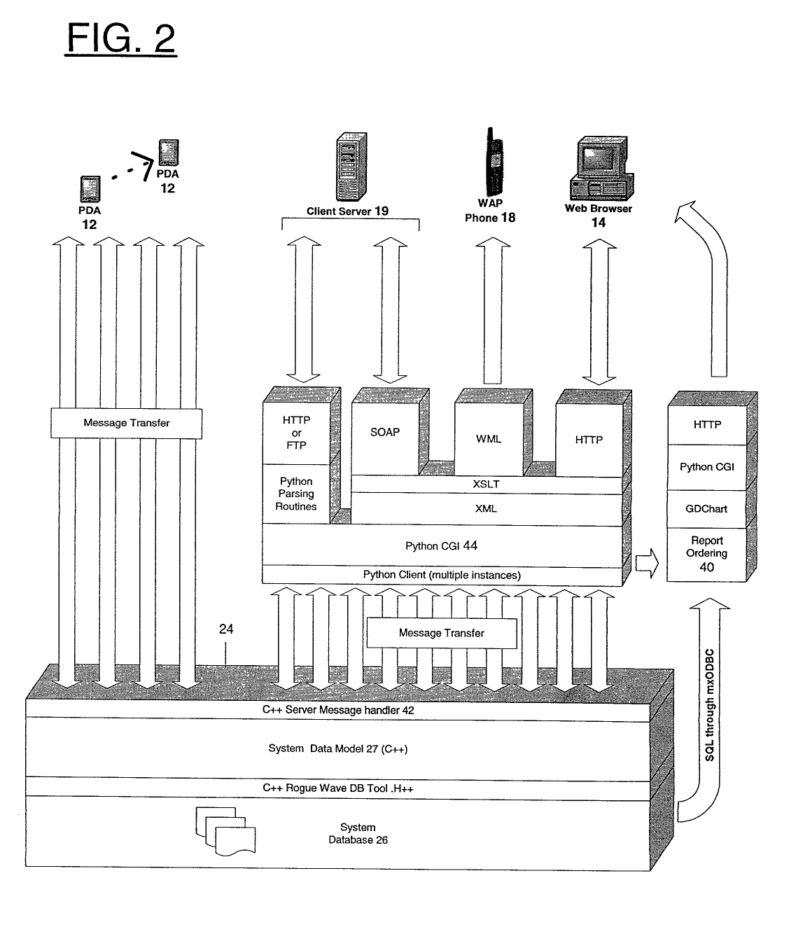

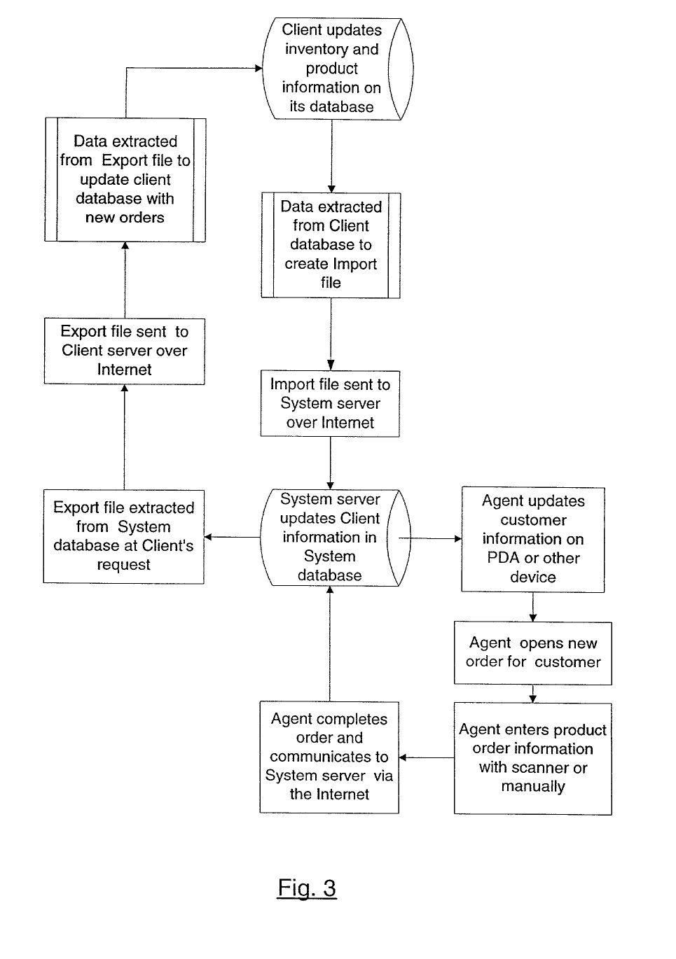

FIG. 2 illustrates the flow of data to the System Server database 26. All messages transfer over the Internet 10 from the client and agents' devices 12, 14, 18, 19 are handled through the C++ Server message handler 42 of System server 24. In the case of communications with PDA's 12, this is handled directly over the Internet through an ISP. However in the case of the other devices, the messages to and from the System server 24 are processed through a CGI program 44, perferably written in the Python programming language, which processes the HTTP protocol messages from the agent web browser at 14, WML (Wireless Markup Language) protocol; from the wireless device 18 or SOAP (Simple Object Acces Protocol), HTTP or FTP protocol from the Client server 19. An XSLT (Extensible Style Language Transformation) processor may be used to transform the XML (Extensible Markup Language) documents into WML, HTML, or any other necessary format, depending upon the device the documents are being sent to. System server 24 also has a report generator 40 which can also produce various reports requested from the agent's web browser, which are prepared from database 26 and communicated to the agent using SQL (Structured Query Language)

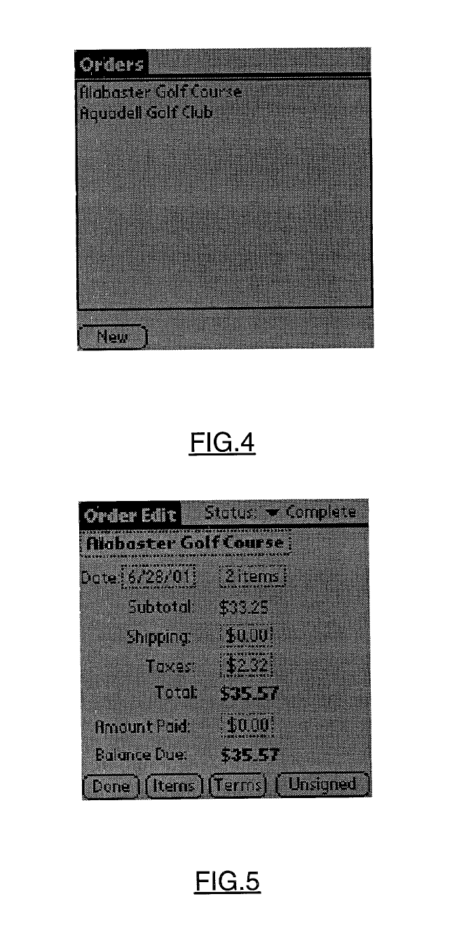

In operation, the sales agent meets a customer of the Client, such as a retail store and has a PDA provided with a bar code scanner and wireless capability, such as a SYMBOL SPT 1733 or 1734, or a HANDSPRING VISOR provided with a SYMBOL CSM 150 scanning module. The sales agent may connect to System server 24 through the Internet to download updated product and inventory information. The sales agent then calls up the PDA screen for a new order for the customer. See FIG. 4. The sales agent then enters the identification for products which the customer wishes to order, which can be done by scanning the bar code, or by selecting the item from a product list on the PDA, and enters the quantity after checking the current inventory. Suitable bar code scanner equipped PDA's are manufactured by Symbol Technologies, models SPT 1733, SPT 1734 and SPT 1740 and the CSM 150 scanning module for a Handspring Visor. After all entries has been made the agent stores a completed order. See FIG. 5. The list of items can be checked before finalizing the completed order. When the agent wishes to finalize the order he connects to the System server 24 to upload the customer order which is relayed to the System server 24. Periodically the client downloads the finalized orders from System server 24 and updates its own database and sends shipping information to its warehouse electronically and debits the customer's account or credit card.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A method of using a global computer network to communicate product sales orders from one of a plurality of customer agents, each said agent having an Internet accessible device with data storage, to one of a plurality of client computer systems, each said client computer system comprising a database of product information, inventory, and customer information, said client computer system being accessible to the Internet; said method comprising:
a) providing a system server accessible to said client computer system via the Internet and comprising a database, said system server thereby being adapted to interactively communicate data to and from said client computer system via the Internet;
b) constructing a client database associated with said system server by periodically updating product information, inventory, and customer information for specific clients and storing in said database said data;
c) said system server being accessible to said agents' devices via the Internet, said system server thereby being adapted to interactively communicate data to and from said agents' devices via the Internet;
d) communicating to one of said agents information relating to a customer from said system server;
e) said agent composing a customer product order and storing same on said device;
f) said agent communicating order information to said system server;
g) said system server updating said client database with said order information;
h) said system server communicating said updated client database information to said client computer system.

2. The method of claim 1 wherein said agent device is a wireless device.

3. The method of claim 1 wherein said agent device comprises a bar code scanner.

4. The method of claim 1 wherein said agent device comprises a computer terminal or interactive television.

5. The method of claim 1 wherein said data in said client database is organized according to customer agents and product categories and product description records for each product;

6. The method of claim 2 wherein said wireless device is selected from the group cellular telephone, mobile phone, smart phone, pager, vehicle onboard data terminal and personal digital assistant.

7. The method of claim 1 wherein said customer information communicated to said agent comprises product inventory information.

8. A system for communicating product sales orders from one of a plurality of customer agents, each said agent having an Internet accessible device with data storage, to one of a plurality of client computer systems, each said client computer comprising a database of product information, inventory, and customer information, said client computer system being accessible to the Internet; said system comprising
a) a system server accessible to said clients via the Internet and comprising a database, said server thereby being adapted to interactively communicate data to and from said client computer system via the Internet;
b) a client database associated with said system server by periodically updating product information, inventory, and customer information for specific clients and storing in said database said data;
c) said system server being accessible to said agents' devices via the Internet, said system server thereby being adapted to interactively communicate data to and from said agents' devices via the Internet;
d) means for communicating to one of said agents information relating to a customer from said system server;
e) means for said agent to compose a customer product order and storing same on said device;
f) means for said agent to communicate order information to said system server;
g) means for said system server to update said client database with said order information; and
h) means for said system server to communicate said updated client database information to said client computer system.

9. The system of claim 8 wherein said agent's device is a computer terminal.

10. The system of claim 8 wherein said agent's device is wireless device selected from the group consisting of cellular telephones, mobile phones, smart phones, pagers, vehicle onboard data terminal and personal digital assistants.

11. The system of claim 8 wherein said data in said client database is organized according to customer agents and product categories and product description records for each product.

12. The system of claim 8 wherein said customer information communicated to said agent comprises product inventory information.

13. A method of using a global computer network to communicate information from one of a plurality of client agents, each said agent having an Internet accessible device, to one of a plurality of client computer systems, each said client computer system comprising a database of information, and to update said information in said client computer system database, said client computer system being accessible to the Internet; said method comprising:
a) providing a system server accessible to said client computer system via the Internet and comprising a database, said system server thereby being adapted to interactively communicate data to and from said client computer system via the Internet;
b) constructing a client database associated with said system server by periodically updating information and storing said information in said database;
c)said system server being accessible to said agents' devices via the Internet, said system server thereby being adapted to communicate information from said agents' devices via the Internet;
d) said agent composing a communication including updated information on said device;
e) said agent communicating said updated information to said system server via the Internet;
f) said system server updating said information in said client database; and
g) said system server periodically communicating said updated information to said client computer system.

14. The method of claim 13 wherein said agent device is a wireless device.

15. The method of claim 13 wherein said agent device comprises a bar code scanner.

16. The method of claim 13 wherein said agent device comprises a computer terminal or interactive television.

17. The method of claim 13 wherein said data in said client database is organized according to customer agents.

18. The method of claim 2 wherein said wireless device is selected from the group cellular telephone, mobile phone, smart phone, pager, vehicle onboard data terminal and personal digital assistant.

19. The method of claim 1 wherein said updated information comprises product ordering information.
